(19) United States
(12) Patent Application Publication
(10) Pub. No.: US 2025/0166032 A1
(43) Pub. Date: May 22, 2025

(54) SYSTEMS AND METHODS FOR A BUY NOW, PAY LATER OFFER FINDER SERVICE

(71) Applicant: Mastercard International Incorporated, Purchase, NY (US)

(72) Inventors: Chirag Navinbhai Zalavadiya, Vadodara (IN); Amar Kumar, Pune (IN); Jash Kashyapbhai Dholakia, Pune (IN); Ketan Tandel, Valsad (IN); Vishal Patil, Pune (IN)

(73) Assignee: Mastercard International Incorporated, Purchase, NY (US)

(21) Appl. No.: 18/510,743

(22) Filed: Nov. 16, 2023

(51) Int. Cl. G06Q 30/0601; G06Q 40/03

(52) U.S. Cl. CPC G06Q 30/0611; G06Q 40/03

(57) ABSTRACT

A system for finding Buy Now, Pay Later (BNPL) offers is programmed to receive BNPL loan product data associated with a BNPL loan available from a BNPL lender. The BNPL loan product data includes one or more of the following: a product, a product category, and a bank identification number (BIN). The system receives a search query from a consumer computing device associated with a consumer. The search query includes product data. The system is programmed to store the BNPL loan product data and the product data from the search query in one or more tables on a database. The system is programmed to determine that the product data in the search query matches at least a portion of the BNPL loan product data. Based on the determination, the system transmits an alert message to the consumer computing device. The alert message includes information identifying the BNPL loan.

### BACKGROUND

The present invention relates generally to installment loans and, more particularly, to identifying Buy Now, Pay Later installment loans offered by merchants associated with consumer products of interest.

Buy Now, Pay Later (BNPL) loans have gained significant popularity in recent years as an alternative payment method for consumers. The concept behind BNPL is relatively simple: it allows customers to make a purchase and defer the payment over a specified period, typically in multiple installments. Instead of paying the full price upfront, consumers can split their payments into more manageable chunks, often with little to no interest if the installments are paid on time.

It is difficult for consumers to find BNPL merchants and BNPL offers that may be associated with the consumer's payment card and/or certain products of interest. Typically, a consumer must travel from one merchant to another to check BNPL offers on specific products that the consumer may wish to purchase. This may be difficult or even impossible for some consumers with mobility issues. Furthermore, consumers may not be aware that BNPL offers already exist on their payment card for specific merchants and/or products. Additionally, consumers may not be made aware of future BNPL offers for specific products they may wish to purchase.

### BRIEF DESCRIPTION

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a Buy Now, Pay Later (BNPL) offer finder service system is provided. The BNPL system includes a database, at least one processor coupled to the database, and a memory device storing computer-executable instructions thereon. The computer-executable instructions cause the at least one processor to receive, from a BNPL lender server, BNPL loan product data associated with a BNPL loan available from a BNPL lender. The BNPL loan product data includes one or more of the following: a product, a product category, and a bank identification number (BIN). The at least one processor is configured to store the BNPL loan product data in one or more tables on the database. Furthermore, the at least one processor receives a search query from a consumer computing device associated with a consumer. The search query includes product data. The at least one processor is configured to store the product data from the search query in one or more additional tables on the database. Additionally, the at least one processor is configured to determine that the product data in the search query matches at least a portion of the BNPL loan product data, and based on the determination, transmit an alert message to the consumer computing device, the alert message including information identifying the BNPL loan.

In another aspect, a computer-implemented method is provided. The method includes receiving, from a Buy Now, Pay Later (BNPL) lender server, BNPL loan product data associated with a BNPL loan available from a BNPL lender. The BNPL loan product data includes one or more of the following: a product, a product category, and a bank identification number (BIN). The method also includes storing the BNPL loan product data in one or more tables in a database. Furthermore, the method includes receiving a search query from a consumer computing device associated with a consumer. The search query includes product data. The method includes storing the product data from the search query in one or more additional tables in the database. Additionally, the method includes determining that the product data in the search query matches at least a portion of the BNPL loan product data, and based on the determination, transmitting an alert message to the consumer computing device, the alert message including information identifying the BNPL loan.

In yet another aspect, a non-transitory computer-readable storage media is provided. The non-transitory computer-readable storage media has computer-executable instructions stored thereon. When the computer-executable instructions are executed by at least one processor, the computer-executable instructions cause the at least one processor to receive, from a Buy Now, Pay Later (BNPL) lender server, BNPL loan product data associated with a BNPL loan available from a BNPL lender. The BNPL loan product data includes one or more of the following: a product, a product category, and a bank identification number (BIN). The computer-executable instructions also cause the at least one processor to store the BNPL loan product data in one or more tables on the database. Furthermore, the computer-executable instructions cause the at least one processor to receive a search query from a consumer computing device associated with a consumer. The search query includes product data. Additionally, the computer-executable instructions cause the at least one processor to store the product data from the search query in one or more additional tables on the database. Moreover, the computer-executable instructions cause the at least one processor to determine that the product data in the search query matches at least a portion of the BNPL loan product data, and based on the determination, transmit an alert message to the consumer computing device, the alert message including information identifying the BNPL loan.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a block diagram of an exemplary system for identifying Buy Now, Pay Later (BNPL) financing, in accordance with an aspect of the present invention;

FIG. 2 is an example configuration of a user computing system for use with the system shown in FIG. 1;

FIG. 3 is an example configuration of a server system for use with the system shown in FIG. 1;

FIG. 4 is a flowchart illustrating an exemplary computer-implemented method for registering a consumer for a BNPL offer finder service, in accordance with one embodiment of the present disclosure; and

FIG. 5 is a flowchart illustrating an exemplary computer-implemented method for identifying relevant BNPL offers made available to a consumer and notifying or alerting the consumer to such BNPL offers, in accordance with one embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Broadly, embodiments provide a system and method for identifying and notifying a consumer of a Buy Now, Pay Later (BNPL) loan offer for one or more products of interest to the consumer. For example, the embodiments described herein may provide a service to identify and provide a notification of a BNPL loan offer for a product previously searched by the consumer (e.g., using a search history of the consumer). In addition, the embodiments described herein may provide a service to identify and provide a notification of nearby merchant locations that are offering a BNPL loan offer on products of interest, for example, based on a location of the consumer and his or her previous search history

### Exemplary System

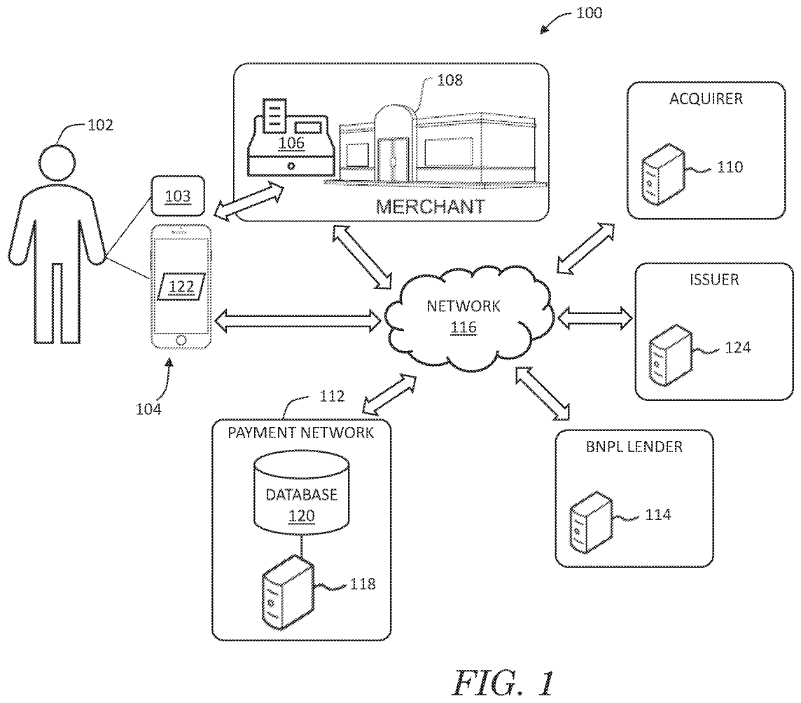

FIG. 1 is a block diagram of an exemplary system 100 for identifying Buy Now, Pay Later (BNPL) financing (e.g., a BNPL loan) and merchant locations offering such financing for products of interest to a consumer 102, in accordance with an aspect of the present invention. In the example, the consumer 102 may have access to consumer computing device 104 through which the consumer 102 may request BNPL financing for a purchase transaction made by the consumer 102.

In the example embodiment, the system 100 may also generally include a merchant 108 having a merchant computer 106 (e.g., a point-of-sale (POS) device or other computing system), a merchant acquirer and its associated computer 110, a payment network 112, a BNPL lender and its associated computer 114 (the reference character 114 may be used herein in association with the BNPL lender and/or the BNPL lender computer), and an issuer and its associated computer 124 (the reference character 124 may be used herein in association with the issuer and/or the issuer computer). The merchant computer 106 may be a data processing device associated with a merchant, such as the merchant 108. In some embodiments, the merchant computer may include a merchant checkout user interface (UI) displayed on a display of the consumer computing device 104 or other data processing device.

The merchant computer 106, the merchant acquirer computer 110, the payment network 112, the BNPL lender computer 114, and the issuer 124 may be coupled in communication via a communications network 116. The network 116 may include, for example and without limitation, one or more of a local area network (LAN), a wide area network (WAN) (e.g., the Internet, etc.), a mobile network, a virtual network, and/or any other suitable public and/or private network capable of facilitating communication among the merchant computer 106, the acquirer computer 110, the payment network 112, the BNPL lender computer 114, and/or the issuer 124. In some embodiments, the network 116 may include more than one type of network, such as a private payment transaction network provided by the payment network 112 to the acquirer computer 110, the BNPL lender computer 114, and the issuer 124, and, separately, the public Internet, which may facilitate communication between the merchant 108, the payment network computer 112, the acquirer computer 110, the BNPL lender computer 114, the issuer 124, and the consumer 102, etc.

Embodiments described herein may relate to a payment card system, such as a credit card payment system using the Mastercard® interchange network. (Mastercard is a registered trademark of Mastercard International Incorporated). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer,” such as the issuer 124, may issue a financial account and an associated payment card, such as a payment card 103, to a consumer, such as the consumer 102. The consumer 102 may use the financial account or payment card 103 to tender payment for a purchase from the merchant 108. Alternatively, the consumer 102 may purchase a product or service from the merchant 108 using a Buy Now, Pay Later (BNPL) option provided to the consumer 102, for example, at the merchant computer 106. The merchant 108 typically may be associated with products, such as goods and/or services, that may be offered for sale and may be sold to the consumer 102. The merchant 108 may include, for example, a physical location and/or a virtual location. A physical location may include, for example, a brick-and-mortar store, etc., and a virtual location may include, for example, an Internet-based store-front.

In the exemplary embodiment, to accept payment with the BNPL option, which may be associated with a virtual payment credential, the merchant 108 must normally establish an account with a financial institution that is part of the system 100. This financial institution is usually called the “merchant bank,” the “acquiring bank,” or an “acquirer,” and may operate an acquirer computer 110 (the reference character 110 may be used herein in association with the acquirer and/or the acquirer computer). When the consumer presents payment for a purchase with, for example, the BNPL option (e.g., a virtual payment credential issued by the BNPL lender computer 114), the merchant 108 may request authorization from the acquirer computer 110 for the amount of the purchase. Typically, the request is performed using the merchant computer 106.

The merchant computer 106 may communicate electronically with one or more transaction processing computers of the acquirer, such as the acquirer computer 110, to transmit the account information associated with the virtual payment credential thereto. Alternatively, the acquirer may authorize a third party to perform transaction processing on its behalf. In this case, the merchant computer 106 will be configured to communicate with the third party. Such a third party is usually called a “merchant processor,” an “acquiring processor,” or a “third party processor.” In some embodiments, the merchant computer 106 may include a merchant checkout user interface (UI) displayed on the consumer computing device 104 or other data processing device.

Using the payment network 112, computers of the acquirer 110 and/or merchant processor may communicate with computers of the BNPL lender 114 to determine whether the virtual payment credential account is in good standing and whether the purchase is covered by the available credit line. Based on these determinations, the request for authorization may be declined or accepted. If the request is accepted, an authorization code may be issued to the merchant 108.

When a request for authorization is accepted, the available credit line of the virtual payment credential account may be decreased. After the merchant 108 ships or delivers the goods or services, the merchant 108 may capture the transaction by, for example, appropriate data entry procedures on the merchant computer. This may include bundling of approved transactions daily for standard retail purchases. If the consumer(s) cancels the transaction before it is captured, a “void” may be generated. If the consumer(s) returns the goods after the transaction has been captured, a “credit” may be generated. The payment network 112 may store the transaction information, such as, and without limitation, a type of merchant, a merchant identifier, a location where the transaction was completed, an amount of purchase, and a date and time of the transaction, in a database, such as the database 120.

After a purchase has been made, a clearing process may occur to transfer additional transaction data related to the purchase among the parties to the transaction, such as the acquirer computer 110, the payment network 112, and the BNPL lender computer 114. More specifically, during and/or after the clearing process, additional data, such as a time of purchase, a merchant name, a type of merchant, purchase information, user account information, a type of transaction, itinerary information, information regarding the purchased item and/or service, and/or other suitable information, may be associated with a transaction and transmitted between parties to the transaction as transaction data, and may be stored by any of the parties to the transaction.

After a transaction is authorized and cleared, the transaction may be settled among the merchant 108, the acquirer, and the BNPL lender. Settlement refers to the transfer of financial data or funds among the merchant 108, the acquirer computer 110, and the BNPL lender computer 114 related to the transaction. Usually, transactions may be captured and accumulated into a “batch,” which may be settled as a group. More specifically, a transaction typically may be settled between the BNPL lender computer 114 and the payment network 112, and then between the payment network 112 and the acquirer computer 110, and then between the acquirer computer 110 and the merchant 108.

Normally, an interchange fee may be paid by the acquirer to the BNPL lender with respect to a particular transaction, including “zero dollar” authorizations. The interchange fee is a fee charged by the payment network 112 (such Mastercard) to the acquirer for processing a payment card transaction. These fees are typically expressed as a percentage of the transaction value, plus a flat fee per transaction. The interchange fee helps to cover the costs associated with processing the transaction, such as fraud prevention and data processing.

In the example, the payment network 112 includes a BNPL offer finder server 118. The BNPL offer finder server 118 may be configured to receive search history, financial account information, and/or location data from a consumer, such as the consumer 102. The search history may include, for example, a specific product or service, product or service category, etc. The financial account information may include a bank identification number (BIN) associated with the consumer's financial account or payment card 103. The BIN may allow the BNPL offer finder server 118 to identify BNPL offers offered by BNPL providers (such as the BNPL lender 114) and/or merchants (such as the merchant 108) that may be associated with a specific BIN or BIN range. Additionally, the location information may include location data identifying a physical or geographic location of the consumer computing device 104, which may generally be associated with the consumer 102.

The BNPL offer finder server 118 may also be configured to receive product data and BNPL loan offerings from BNPL lenders, such as the BNPL lender 114. For example, a BNPL loan offering or program may include a credit amount, limit, or value, a product SKU (shop-keeping unit) or SKUs associated with the BNPL loan offering, a date range specifying when the BNPL loan offer is valid, payment card BIN or BIN ranges, restrictions, and the like.

The BNPL offer finder server 118 may also be configured to receive product data and available BNPL offers from merchants, such as the merchant 108. For example, the merchant 108 may provide a product SKU or SKUs associated with any BNPL loan offers that the merchant 108 may offer to its customers, such as the consumer 102. For example, the merchant 108 may have a working relationship with one or more BNPL lenders, such as the BNPL lender 114, and may select to offer one or more BNPL loans from the BNPL lender 114 to its customers.

In the example, the BNPL offer finder server 118 may also be configured to identify and notify consumers, such as the consumer 102, of BNPL offers that are associated with products the consumer has searched for and/or are available from merchants proximate the consumer based on the location data provided by the consumer computing device 104. The notifications or alerts may be communicated to the consumer 102, for example, via a push notification to the consumer computing device 104, a short messaging service (SMS) message, an email message, and the like. Based on the notifications, the consumer 102 may select to avail himself or herself to the merchant and accept a BNPL offer.

### Exemplary Computer Systems

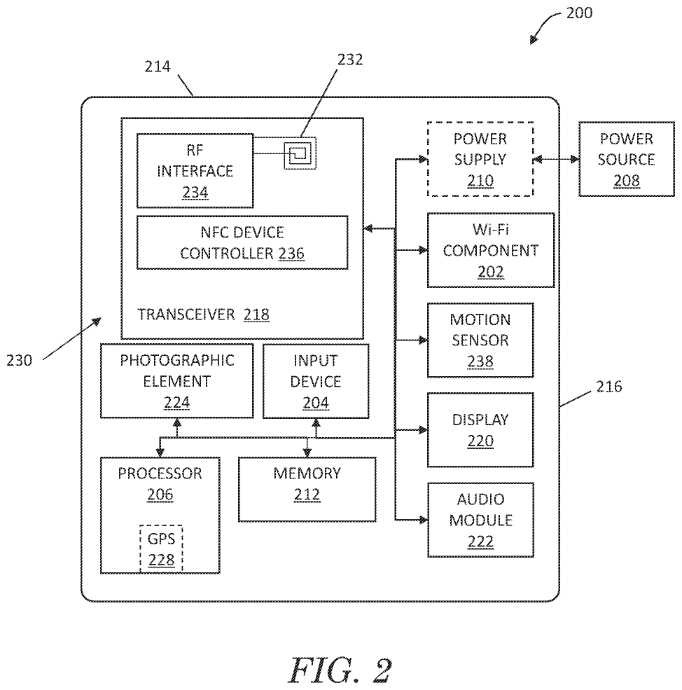

FIG. 2 is an example configuration of a user computing system 200, such as the consumer computing device 104 (shown in FIG. 1) that may be operated by a user, such as the consumer 102 (shown in FIG. 1). In the exemplary embodiment, the computing system 200 may be a computing device configured to connect wirelessly to one or more of the merchant 108, the BNPL lender 114, the network 116, and any other computing devices associated with the system 100.

In the exemplary embodiment, the computing system 200 may generally include a processor 206, a memory device 212, a transceiver 218 (or a wireless communication device), and a photographic element 224. In addition, the computing system 200 may include an integrated Wi-Fi component 202 (e.g., implementing the Institute of Electrical and Electronics/IEEE 802.11 family of standards), an input device 204, a display 220, and an audio module 222. Moreover, the computing system 200 optionally may include an internal power supply 210 (e.g., a battery or other self-contained power source) to receive power, or alternatively, in some embodiments, the computing system 200 may include an external power source 208. Optionally, the computing system 200 may include a motion sensor 238.

The processor 206 may include one or more processing units (e.g., in a multi-core configuration) specially programmed for executing computer readable instructions. The instructions may be executed within a variety of different operating systems (OS) on the computing system 200, such as UNIX, LINUX, Microsoft Windows®, etc. More specifically, the instructions may cause various data manipulations on data stored in the memory device 212 (e.g., create, read, write, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). The memory device 212 may be any device allowing information such as payment card data, the executable instructions, and/or other data to be stored and retrieved. The memory device 212 may include one or more computer readable media.

In the example embodiment, the processor 206 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 200 may be widely deployed, it may be impractical to manually update software for each computing system 200. Therefore, the system 100 may provide a mechanism for automatically updating the software on the computing system 200. For example, an updating mechanism may be used to automatically update any number of components and their drivers, both network and non-network components, including system level (OS) software components. In some embodiments, the components of the computing system 200 may be dynamically loadable and unloadable; thus, they may be replaced in operation without having to reboot the OS.

A location of the computing system 200 may be obtained through conventional methods, such as a location service (e.g., global positioning system (GPS) service) in the computing system 200, “ping” data that includes geotemporal data, from cell location register information held by a telecommunications provider to which the computing system 200 may be connected, and the like. For example, in one suitable embodiment, a GPS chip 228 may be part of or separate from the processor 206 to enable the location (or geolocation) of the computing system 200 to be determined.

The Wi-Fi component 202 (broadly, a communication interface) may be communicatively connectable to a remote device such as the merchant computer 106 and the network 116. The Wi-Fi component 202 may include, for example, a wireless or wired network adapter or a wireless data transceiver for use with Wi-Fi (e.g., implementing the Institute of Electrical and Electronics/IEEE 802.11 family of standards), Bluetooth communication, radio frequency (RF) communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 212 may be, for example, computer readable instructions for providing a user interface to the user, such as the consumer 102, via the display 220 and, optionally, receiving and processing input from the input device 204. A user interface may include, among other possibilities, a web browser, a client application, a digital wallet, and the like. Web browsers may enable users, such as the consumer 102, to view and interact with media and other information typically embedded on a web page or a website. A client application, such as a BNPL offer finder service application 122 (shown in FIG. 1), may allow the consumer 102, to interact with a server application, for example, associated with the BNPL offer finder server 118 and/or any other computing system associated with the system 100. A digital wallet may allow the consumer 102, to receive, generate, and/or store payment credentials, such as tokens associated with the payment card 103 and/or the virtual payment credential.

The photographic element 224 may include a camera or other optical sensor and lens combination capable of generating a video signal and capturing an image, iris scan, and the like. In various embodiments, the photographic element 224 may be integrated in a housing or body, such as a housing 214, of the computing system 200. When the photographic element 224 captures an image or otherwise generates image data (e.g., video data), the photographic element 224 may store the image data in a data file, either in a raw or compressed format, in the memory device 212.

In some embodiments, the motion sensor 238 may include one or more sensor elements that facilitate detecting a person's presence. For example, the motion sensor 238 may detect when the consumer 102 moves or raises the user consumer system 200. Upon detection of such motion, the photographic element 224 may begin capturing images (e.g., still or video images), the transceiver 218 may be activated, and/or the audio module 222 may begin capturing audio. The motion sensor 238 may be operatively coupled to the photographic element 224 such that the consumer's presence may be detected by detecting motion using the photographic element 224. The motion sensor 238 may include, for example, and without limitation, sensor elements such as a passive infrared sensor, an ambient light sensor, and the like.

In the example embodiment, the display 220 may include, for example, and without limitation, a liquid crystal display (LCD), an organic light emitting diode (OLED) display, or an “electronic ink” display. In some embodiments, a single component such as a touch screen may function as both an output device (e.g., the display 220) and the input device 204. As such, the display 220 may optionally include a touch controller for support of touch capability. In such embodiments, the computing system 200 may detect the presence of the consumer 102, for example, by detecting that the consumer 102 has touched the display 220 of the computing system 200.

The audio module 222 may include, for example, and without limitation, a speaker and related components capable of broadcasting streaming and/or recorded audio and may also include a microphone. The microphone facilitates capturing audio through the computing system 200.

In the example embodiment, the computing system 200 includes the housing 214 at least partly (and more preferably, at least substantially or entirely) enclosing the components described above. In addition, the computing system 200 includes circuitry 230 configured to communicate with the network 116 (shown in FIG. 1) and/or other computing devices (e.g., other mobile devices, the computers or systems 106, 110, 112, 114, 118, and 124, etc.). The circuitry 230 may include, for example, leads, connectors, NFC-enabled circuitry, Wi-Fi-enabled circuitry, and photographic element circuitry. The housing 214 is preferably configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the computing system 200. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 may be fabricated from a suitably selected material that facilitates inhibiting the effect the material has on the signal being emitted from, for example, the transceiver 218 and/or the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 may be fabricated from any material that enables the computing system 200 to function as described herein, such as metals, etc.

In one embodiment, the transceiver 218 may include an antenna 232. The antenna 232 includes a looped wire configured to transmit radio signals when current flows through the looped wire. The antenna 232 is any size, shape, and configuration that is suitable for transmitting signals as described herein. For example, the antenna 232 may be a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 may be configured to vibrate at a frequency of about 13.56 MHz, which is suitable for use in a near field communication (NFC) system.

In the example embodiment, the antenna 232 may transmit radio signals to and may receive radio signals from other wireless-enabled computing devices, for example, another mobile device, the computers or systems 106, 110, 112, 114, 118, and 124, and/or any other components used in wireless systems. In NFC systems, for example, at least one NFC component generates a magnetic field to inductively transfer currents and, thereby, exchange signals and information with other NFC components positioned within the magnetic field. In one example embodiment, the antenna 232 may function as an NFC component to send and receive signals. The antenna 232 may be configured to transmit radio signals to NFC components positioned within the magnetic field of the antenna 232, such as when the computing system 200 is positioned within a predetermined distance of the merchant computer 106. Therefore, the magnetic field generated by the antenna 232 may define the active range of the computing system 200. Additionally, the antenna 232 may receive radio signals from NFC components when the antenna 232 is positioned within the magnetic field of the NFC components.

The transceiver 218 also may include a radio frequency (RF) interface 234 and an NFC device controller 236. The RF interface 234 and the NFC device controller 236 may be powered by the power source 208, and in some embodiments, the internal power supply 210 and/or the display 220. In addition, the processor 206 and the memory device 212 may be powered in the same manner. The RF interface 234 may be configured to receive and transmit RF signals through the antenna 232. The NFC device controller 236 may be configured to process the received RF signals and to generate signals to be transmitted by the RF interface 234. The memory device 212 may be configured to store data associated with transmitting and receiving the RF signals. The NFC device controller 236 may be coupled in communication with the processor 206.

In some embodiments, the computing system 200 may be connected to one or more peripheral devices (not shown). That is, the computing system 200 may communicate various data with one or more peripheral devices. For example, the computing system 200 may communicate with one or more peripheral devices through the Wi-Fi component 202, the transceiver 218, or other suitable means.

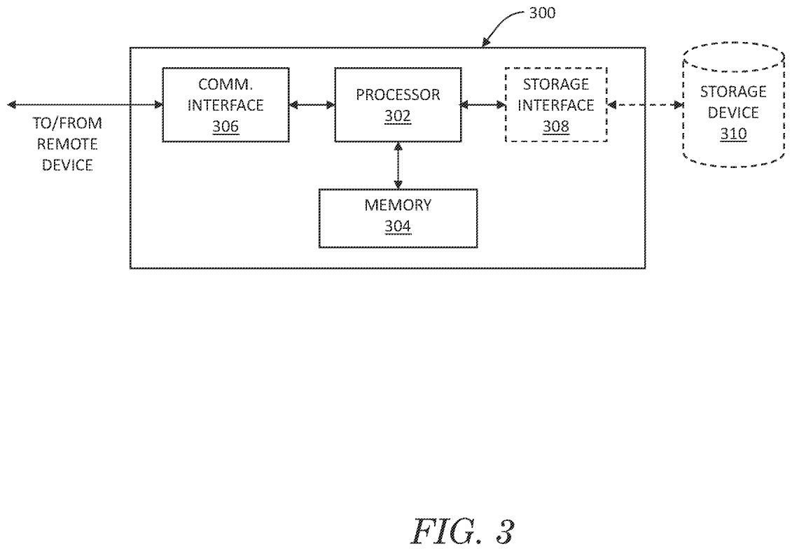

FIG. 3 is an example configuration of a server system 300. In an embodiment, the server system 300 may include, but not be limited to, the merchant computer 106, the acquirer computer 110, the BNPL lender computer 114, and/or the BNPL offer finder server 118 (all shown in FIG. 1). In the example embodiment, the server system 300 may include a processor 302 for executing instructions. The instructions may be stored in a memory 304, for example. The processor 302 may include one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 302 may be operatively coupled to a communication interface 306 such that the server system 300 can communicate with a remote device such as a user computing system 200 (shown in FIG. 2), one or more of the computers or systems 104, 106, 110, 112, 114, 118, and 124, and/or another server system. For example, the communication interface 306 may receive communications from a consumer computing device 104 via the Internet (FIG. 1).

The processor 302 may be operatively coupled to the storage device 310. The storage device 310 may be any computer-operated hardware suitable for storing and/or retrieving data. In some embodiments, the storage device 310 may be integrated in the server system 300. In other embodiments, the storage device 310 may be external to the server system 300. The storage device may be similar to the 120 (shown in FIG. 1). For example, the server system 300 may include one or more hard disk drives as the storage device 310. In other embodiments, the storage device 310 may be external to the server system 300 and may be accessed by a plurality of server systems 300. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 may be operatively coupled to the storage device 310 via a storage interface 308. The storage interface 308 may be any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory 304 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Computer-Implemented Methods

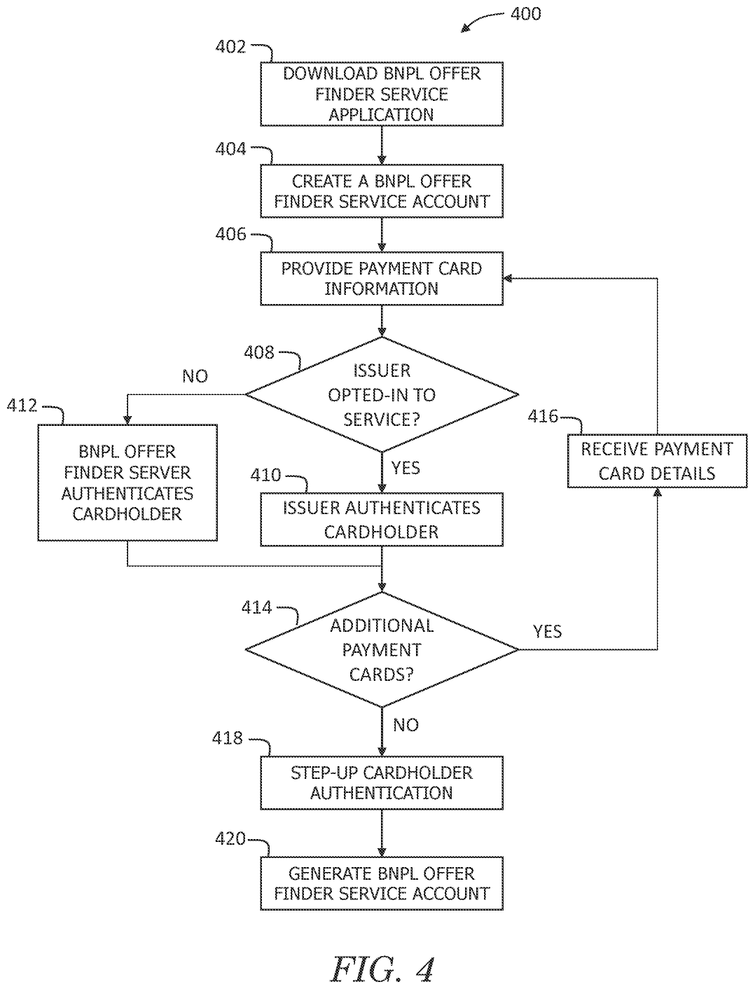

FIG. 4 is a flowchart illustrating an exemplary computer-implemented method 400 for registering a consumer, such as the consumer 102, for a Buy Now, Pay Later (BNPL) offer finder service, in accordance with one embodiment of the present disclosure. The steps described herein may be performed in the order shown in FIG. 4 or may be performed in a different order. Furthermore, some steps may be performed concurrently as opposed to sequentially. In addition, some steps may be optional.

The computer-implemented method 400 is described below, for ease of reference, as being executed by exemplary devices and components introduced with the embodiments illustrated in FIGS. 1-3. In one embodiment, the method 400 may be implemented by the payment network 112 (shown in FIG. 1), and more particularly, by the BNPL offer finder server 118. In the exemplary embodiment, the method 400 generally concerns the receipt of consumer registration information from the consumer computing device 104 (shown in FIG. 1) upon registration for the BNPL offer finder service. While steps within the method 400 are described below regarding the consumer computing device 104, the method 400 may be implemented on other such computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

Referring to step 402, in the example embodiment, the consumer 102 may download the BNPL offer finder service application 122 (shown in FIG. 1). For example, the consumer 102 may connect to the BNPL offer finder server 118, which may instruct the consumer 102 to download the BNPL offer finder service application 122 to the consumer computing device 104 for direct communication with the BNPL offer finder server 118 via the payment network 112, e.g., without use of a web browser. When the consumer 102 uses the BNPL offer finder service application 122, a direct link may be established via a wireless connection, for example, via a Wi-Fi connection to the network 116.

Referring to step 402, the consumer 102 may download the BNPL offer finder service application 122. The consumer computing device 104, such as a web-based smartphone, may be configured to execute for display the BNPL offer finder service application 122. In some embodiments, the BNPL offer finder service application 122 may be stored in a cloud-based interface, which may include cloud storage capability as well as any cloud-based API that facilitates communication between the consumer computing device 104 and BNPL offer finder server 118. The BNPL offer finder service application 122 may facilitate transmitting and receiving data between the consumer computing device 104 and BNPL offer finder server 118 for enrolling the consumer and identifying and notifying the consumer of relevant BNPL offers available to the consumer, as described further herein.

At step 404, the consumer 102 may be presented with an option to create a BNPL offer finder service account. For example, the consumer 102 may enroll for the BNPL offer finder service via the BNPL offer finder service application 122 or via a suitable webpage of the BNPL offer finder server 118 using, for example, the consumer computer system 104. The consumer 102 may enroll or register with the BNPL offer finder service in any of several ways, including utilizing the consumer computer system 104 to access the BNPL offer finder server 118 via the Internet and providing required information. During consumer enrollment, the consumer 102 may provide enrollment data including basic information about himself or herself (e.g., name, address, phone number, etc.) and, in some embodiments, provide information regarding the customer's mobile devices (for example, by providing a SIM identifier and/or a mobile telephone number and/or other device identifier). In addition, the consumer 102 may provide information and/or preferences concerning one or more family members, such as a spouse and/or children to form a “Household” BNPL offer finder service account. It is noted that the BNPL offer finder service account may be linked to other Mastercard services if the consumer 102 is already signed up for other services. In some embodiments, the information obtained from the consumer 102 during the enrollment process may include product and/or service preferences, and/or other information.

At step 406, the consumer 102 may also provide information concerning his or her payment card 103, e.g., bank credit card account, debit card account, and/or prepaid card issued to or held by him or her, including the BIN. At step 408, the BNPL offer finder server 118 may determine whether the issuer 124 of the payment card 103 has opted-in to the BNPL offer finder service. If the issuer 124 has chosen to opt-in to the BNPL offer finder service, at step 410 the issuer 124 may authenticate the consumer 102 in real-time. For example, and without limitation, the issuer 124 may authenticate the consumer 102 via a one-time code sent to the consumer 102 via Short Message Service (SMS), e-mail, through an issuer mobile application, through a call center communication, and the like. In the exemplary embodiment, issuer authentication may be the preferred method for authenticating the consumer 102, as the issuer 124 and the consumer 102 have a direct relationship.

If the issuer 124 has not chosen to opt-in to the BNPL offer finder service and therefore does not participate in the enrollment process, at step 412, the BNPL offer finder server 118 may authenticate the consumer 102. For example, and without limitation, the consumer 102 may be asked to input a string of characters indicating a code printed on the signature panel of the consumer's payment card 103. For example, the signature panel code may be a card verification code (CVC) value. The values entered by the consumer 102 may be used by the BNPL offer finder server 118 to authenticate the consumer 102 prior to setting up the BNPL offer finder service account and associating the consumer 102 and the payment card 103 with the account. For example, the BNPL offer finder server 118 may compare the entered values to the values associated with the payment card stored in a database (e.g., the database 120 shown in FIG. 1). If the entered values match the stored values, the consumer 102 may be authenticated. While this method allows the consumer 102 to be authenticated, it may not be as strong of an authentication or verification that the issuer 124 could provide. Optionally, the method 400 may include an additional step for authenticating the consumer 102 offline. For example, and without limitation, the BNPL offer finder server 118 may provide an offline PIN to the consumer 102 via mail.

At step 414, the BNPL offer finder server 118 may ask the consumer 102 whether the consumer has additional payment cards he or she wishes to associate with the consumer's BNPL offer finder service account. If the consumer has additional payment cards to enter, at step 416, the BNPL offer finder server 118 may receive the payment card details from the consumer 102 and return to step 406. If the consumer does not have any additional payment cards to enter, the method may continue to step 418.

At step 418, the BNPL offer finder server 118 may request that the consumer 102 set up a step-up authentication method, i.e., two-factor authentication. The additional authentication measures may be taken before the transactions may be entered into the BNPL offer finder service by the consumer 102. For example, and without limitation, in one embodiment, the consumer 102 may be requested to establish account access credentials, e.g., to select a username and password or PIN (personal identification number) to be used for security purposes, and/or for use by the consumer 102 to login and change one or more preference and/or requirement settings. In addition to the password or PIN, the consumer 102 may be requested to set up a second authentication factor, including, for example, and without limitation, providing a biometric sample that is to be associated with the other registration information provided.

Biometric samples may include, without limitation, a fingerprint image, a voice recording, a retinal image, facial recognition, palm print image, iris recognition, and the like. The biometric sample may be unique to the consumer 102 and difficult to duplicate and/or forge by an unauthorized user. The biometric sample may be stored and associated with a biometric identifier, for example, by the BNPL offer finder server 118 (e.g., in the database 120). Additionally, the biometric identifier may be associated with the stored registration information and may facilitate secure authorization of information input by the consumer 102. A biometric input device in communication with the consumer computing device 104 may be used for the consumer 102 to enter the biometric sample. For example, the consumer computing device 104 may include an integral fingerprint or palm reader/scanner, retinal or iris reader/scanner, and/or voice reader/recorder.

In other suitable embodiments, the second factor may include, for example, and without limitation, SMS two-factor authentication (where a one-time use short code in sent to the consumer's mobile device via SMS), Time-Based One Time Password (TOTP) authentication (where an authenticator application provides a short code as a second factor), push-based two-factor authentication (where a prompt is sent to the consumer's mobile device), or any other two-factor authentication method that enables the method 400 to operate as described herein.

At step 420, the BNPL offer finder server 118 may generate the BNPL offer finder service account or profile for the consumer 102, associating the consumer's payment card 103 (and any additionally added payment cards) with the consumer's profile, along with the consumer's account access credentials.

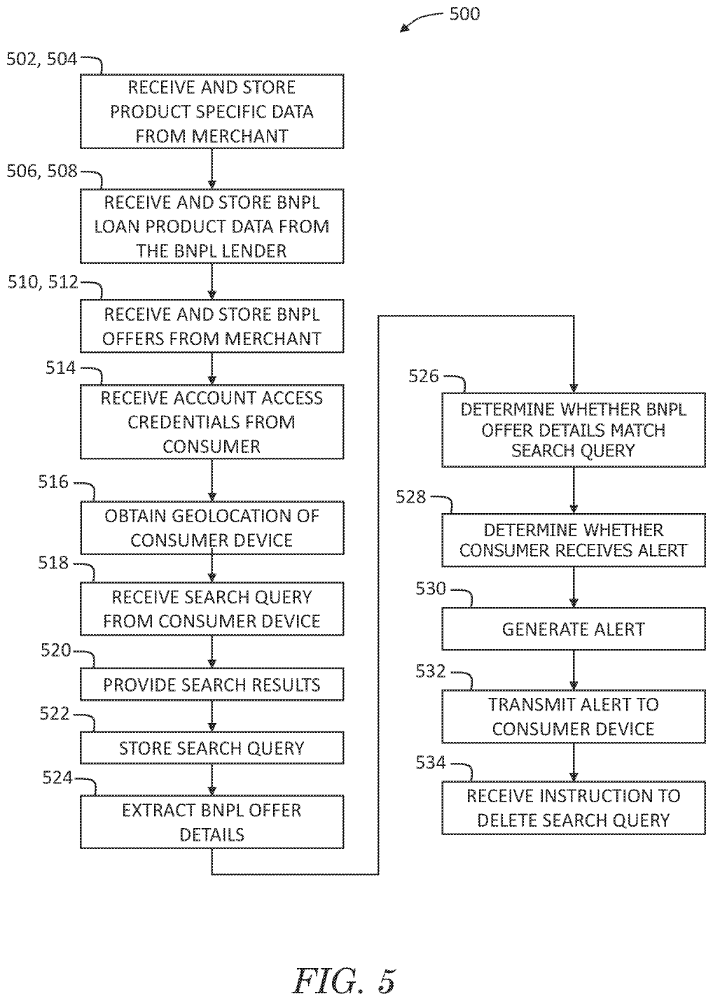

FIG. 5 is a flowchart illustrating an exemplary computer-implemented method 500 for identifying relevant Buy Now, Pay Later (BNPL) offers made available to a consumer, such as the consumer 102, and notifying or alerting the consumer to such BNPL offers, in accordance with one embodiment of the present disclosure. The steps described herein may be performed in the order shown in FIG. 5 or may be performed in a different order. Furthermore, some steps may be performed concurrently as opposed to sequentially. In addition, some steps may be optional.

The computer-implemented method 500 is described below, for ease of reference, as being executed by exemplary devices and components introduced with the embodiments illustrated in FIGS. 1-3. In one embodiment, the method 500 may be implemented by the payment network 112 (shown in FIG. 1), and more particularly, by the BNPL offer finder server 118. In the exemplary embodiment, the method 500 identifies relevant BNPL loan offerings available to a consumer based on the consumer's search history and/or current location. While steps within the method 500 are described below regarding the BNPL offer finder server 118, the method 500 may be implemented on other computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, at step 502 the BNPL offer finder server 118 may receive product specific data, such as stock keeping unit (SKU) data, from one or more merchants, such as the merchant 108 (shown in FIG. 1). In some embodiments, the BNPL offer finder server 118 may receive an alternative product/goods identifier other than SKU data. Moreover, the BNPL offer finder server 118 may receive product specific data from one or more merchant computers 106, such as by QR/barcode scanning, inventory managements systems, etc. The product specific data may additionally include, without limitation, image and/or text data, an item category, one or more characteristics or attributes, and the like. For example, an item category may include food and beverage, clothing, electronics, apparel, sporting goods, books, media type, or other methods of describing a product. The one or more characteristics or attributes may include, for example, tangible and intangible characteristics or attributes. Tangible product attributes may include physical characteristics such as size, weight, and color, whereas intangible product attributes may include non-physical features such as price, quality, aesthetics, etc.

At step 504, the BNPL offer finder server 118 may store the product specific data in a relational database, such as the database 120 (shown in FIG. 1). The database 120 may include one or more tables and include a record for each respective product. The record may include the product name and its corresponding SKU data, and any other unique values associated with the product. The one or more tables may include category information, characteristics and attributes, etc., which may be related to the products. Typically, in a relational database, the rows of product name data stored, for example, in a product name table (e.g., a referenced table), are associated with a unique identifier for easy access and identification. The unique identifier assigned to a product name record may be unique to the associated product data with respect to other identifiers used for all of the product data stored in the product name table. Such an identifier may be referred to as a “primary key” of that table. The rows of category information, characteristics and attributes, etc., which may each be stored in its own table(s) (e.g., a referencing table(s)), may also be associated with an identifier that may reference the associated product name table. Such an identifier may be referred to as a “foreign key.” A foreign key is a field in a referencing table that is the same as the primary key in a referenced table. As such, the category, characteristics, and attributes data in the individual referencing tables may reference specific product name data in the product name table. For example, and without limitation, the product name table may contain SKU data associated with specific products or product names. A category table may contain data corresponding to product categories cardholders associated with specific ones of the products or product names. In such an example, the product or product name may be used as a primary key in the product name table (identifying specific products) and a foreign key in the category table (linking category information to the identifying products). Accordingly, a query to the database 120 that includes any of a product name, SKU, category, characteristic, and/or attribute may return a list of products that include one or more of the queries items.

At step 506, the BNPL offer finder server 118 may receive BNPL loan product data from the BNPL lender, for example, via the BNPL lender computer 114. In the exemplary embodiment, the BNPL lender 114 may create one or more BNPL loan products and submit them to the payment network 112. Each BNPL loan product may be associated with one or more products (e.g., product name, SKU, category, characteristic, attribute, etc.), product categories, merchants, and payment cards (e.g., a BIN or BIN range). Furthermore, the BNPL loan products may include specific terms, such as a number of payments, an interest rate(s) (if any), a payment schedule, etc. At step 508, the BNPL offer finder server 118 may store the BNPL loan product data in the relational database, such as the database 120, in one or more tables, as described above with respect to step 504.

At step 510, the BNPL offer finder server 118 may receive one or more BNPL offers from the one or more merchants, such as the merchant 108 (shown in FIG. 1). The one or more BNPL offers may be BNPL loan offerings provided by BNPL lenders and may include a range of offerings, such as BNPL offers associated with specific products, product categories, an amount spent by the consumer 102 at the merchant, specific payment cards (e.g., a BIN or BIN range), and the like. As part of the one or more BNPL offers, each merchant may also include a merchant location or locations where the one or more BNPL offers may be offered or available. At step 512, the BNPL offer finder server 118 may store the one or more BNPL offers and merchant locations from the one or more merchants in the relational database, such as the database 120, in one or more tables, as described above with respect to step 504.

In the exemplary embodiment, at step 514 the BNPL offer finder server 118 may receive login credentials from the consumer 102 and provide access to the consumer 102 to the BNPL offer finder service. Alternatively, if the consumer 102 has not previously registered for an account with the BNPL offer finder service, the BNPL offer finder server 118 may receive registration information from the consumer 102. The registration information may be associated with a consumer 102 registering for the BNPL offer finder service, as described in detail above with respect to method 400.

After the consumer 102 has registered for and logged into the BNPL offer finder server 118, at step 516, the consumer 102 may enable the BNPL offer finder service application 122 to obtain a geolocation of the consumer computing device 104. For example, and without limitation, the consumer 102 may toggle or set a setting of the BNPL offer finder service application 122 that enables the BNPL offer finder service application 122 to passively obtain the GPS coordinates (i.e., geolocation or location data) of the consumer computing device 104 in the background. A unique identification number can be assigned by a mobile network provider in lieu of providing the matching consumer computing device 104 number to the BNPL offer finder server 118 in order to maintain privacy.

At step 518, the BNPL offer finder server 118 may receive a search query from the consumer computing device 104. The search query may include, for example, product data associated with a product or item of interest to the consumer 102. The consumer computing device 104 may provide the search query through the BNPL offer finder service application 122, which provides access to an electronic search engine provided by the BNPL offer finder server 118. In an example, the consumer computing device 104 may receive text from the consumer 102 when the consumer taps or clicks letters (or numbers) to include with the search query. In another example, a text box provided by the BNPL offer finder service application 122 may be populated by receiving a voice command or an image of an item to be searched. For example, a text box may receive “Mobile Phone” as text, a voice command, or an image of the item “Mobile Phone.” The consumer computing device 104 may provide the search query to retrieve any type of information or access to items.

At step 520, the BNPL offer finder server 118 may provide search results to the consumer 102. The search results may be provided to a user interface UI (not shown) of the BNPL offer finder service application 122 and include the product(s), merchant(s), and/or BNPL offerings that are associated with the search query. In an example, the UI associated with the search results may allow the consumer 102 to filter the search results. For example, the search query may include “Mobile Phone,” as described above, and the search results may include any product, merchant, and/or BNPL offering associated with “Mobile Phones.” The BNPL offer finder service application 122 may the receive an input or interaction with the UI that limits the search results to “Apple Mobile Phones” and “located at merchants near me.” The UI may subsequently limit the items presented on the UI to items that correspond with the search query and selected filter. In the example embodiment, the consumer 102 may select to purchase a product that was associated with the search query based on one or more items returned in the search results. Alternatively or additionally, the search results may not include any product, merchant, and/or BNPL offering in the search results that the consumer 102 is currently inclined to purchase. Thus, the consumer 102 may choose to execute a new search or close the BNPL offer finder service application 122.

At step 522, the BNPL offer finder server 118 may store the information or product data associated with the search query, for example, with the consumer's BNPL offer finder service account or profile as search history. The information associated with the search query may be stored in the database 120, for example, in one or more tables that may enable the BNPL offer finder server 118 to parse and extract certain features and/or terms from the search query.

The BNPL offer finder server 118 may continue to receive BNPL loan product data from the BNPL lender(s) and/or product information and BNPL loan offerings from the merchant(s), for example, over a period of time. In addition, the BNPL offer finder server 118 may continue to receive search queries from the consumer 102.

At step 524, the BNPL offer finder server 118 may extract details from the product data or information and/or queries it receives, for example, from BNPL lender(s), merchant(s), and the consumer 102. The details may include, for example, product names and SKUs, BNPL offerings associated with the product names and SKUs, BINs or BIN ranges associated with the BNPL offerings, merchant location data for the merchant 108 that may be providing relevant BNPL offerings, etc.

At operation 526, the BNPL offer finder server 118 may determine whether any search query information (e.g., at least a portion of the product data) submitted by the consumer 102 matches with at least a portion of the any of the BNPL loan product data, product names and SKUs, BNPL offerings associated with the product names and SKUs, BINs or BIN ranges associated with the BNPL offerings, etc. For example, based on the consumer search history stored by the BNPL offer finder server 118, the sever 118 may compare a new BNPL loan product for an “Apple Mobile Phone” to the consumer's previous search query for an “Apple Mobile Phone.” Further, the BNPL offer finder server 118 may then determine whether the merchant location data associated with any of the relevant BNPL offerings matches the location data of the consumer computing device 104, for example, within a predetermined threshold distance. Furthermore, the BNPL offer finder server 118 may retrieve the BNPL offer finder service account or profile for the consumer 102 from the database 120. The BNPL offer finder server 118 may analyze the information and data stored in the BNPL offer finder service account or profile to determine whether the data or information indicates that the consumer 102 selected to receive alert messages corresponding to the BIN or BIN ranges associated with BNPL offerings.

If there is a match based on the comparison of one or more product names and SKUs, BINs or BIN ranges associated with the BNPL offerings, new BNPL offerings by merchants, etc. to the extracted details of the consumer's historical search queries, and/or if the merchant location data and the location data received from the consumer computing device 104 are within the predetermined threshold distance, at operation 528, the BNPL offer finder server 118 determines whether the consumer selected to receive an alert message. As described herein, the consumer 102 may register with the BNPL offer finder service. The consumer 102 may also select to receive alert messages based on products or BNPL offerings associated with certain user-searched items.

At operation 530, if the consumer 102 selected to receive an alert message corresponding to the identified information, the BNPL offer finder server 118 may generate a corresponding alert message. In the exemplary embodiment, the alert message may be generated in real time or near real time. As used herein, the term “real time” includes the time of occurrence of the associated events, the time to process data, and/or the time of a system response to the events and the environment. In the embodiments described herein, these activities and events occur substantially instantaneously.

In the exemplary embodiment, the alert message may contain information specific to search query. For example, the electronic alert message may contain information identifying matching product information and/or associated BNPL loan offerings, including, without limitation, a name of the merchant 108, a location of the merchant 108, a date the BNPL offering is available, terms and conditions of the BNPL offering, and the like. This information may be used by the BNPL offer finder server 118 to generate the alert message.

The alert messages are generated in a format that can be received by and presented to the consumer 102, for example, on the consumer computing device 104. The alert message sent to a mobile device may be in a particular format and may conform to requirements defined by a mobile network operator. For example, and without limitation, a mobile network operator may specify that an SMS message has limitations on a number of characters and/or a pre-determined memory size (e.g., bits, bytes, etc.).

At operation 532, the BNPL offer finder server 118 may transmit the alert message to the consumer 102. In particular, the BNPL offer finder server 118 may transmit the alert message to the consumer computing device 104 (e.g., a device identified by the mobile device identifier described herein) via a preferred method of delivery selected by the consumer 102 and stored as part of the BNPL offer finder service account or profile for the consumer 102. In some embodiments, the preferred method of delivery may include, for example, and without limitation, the form of a push notification, an interactive voice response (IVR), an instant message (IM), an SMS message, an email message, a web-based application message (e.g., via a digital wallet payment application, etc.), or any other suitable message form transmitted, in this example, to the consumer computing device 104. It should be understood that other alert message content and/or a different delivery method may be defined by the consumer in the BNPL offer finder service data stored in the BNPL offer finder service account or profile for the consumer 102.

The alert message may also include a request to the consumer 102 to respond to the alert message with one of several responses. For example, in an embodiment, the alert message may include a request to the consumer to postpone or snooze the message, reject the message, or reject the message and delete or otherwise remove the historical search information that resulted in the alert message. In this manner, the consumer 102 can continue to be notified of the matching offers or prevent additional matching offers from being presented to him or her based on his or her search history.

Accordingly, in the above-described method, a consumer, such as the consumer 102 may be notified of new BNPL loan offerings for products of interest based on the consumer's previous search history. Additionally or alternatively, the consumer 102 may be notified of nearby or proximate merchants, such as the merchant 108, that are providing BNPL offerings associated with specific products of interest to the consumer 102. Based on the alert messages received at the consumer computing device 104, the consumer 102 may choose to avail himself or herself of a particular BNPL offering, which in some circumstances, were it not for the alert message, the consumer 102 may not be made aware of such offering.

At step 534, the consumer 102 may delete or remove his or her search history or items of interest from the BNPL offer finder server 118, for example, via the BNPL offer finder service application 122. For example, the consumer 102 may delete individual search queries, specify time limits or expirations for storing search queries, etc. As such, the consumer 102 has control to stop receiving alert messages related to any of his or her historical searches at any time.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A Buy Now, Pay Later (BNPL) offer finder service system comprising:
a database,
at least one processor coupled to the database; and
a memory device storing computer-executable instructions thereon, the computer-executable instructions causing the at least one processor to:
receive, from a BNPL lender server, BNPL loan product data associated with a BNPL loan available from a BNPL lender, the BNPL loan product data including one or more of the following: a product, a product category, and a bank identification number (BIN);
store the BNPL loan product data in one or more tables on the database;
receive a search query from a consumer computing device associated with a consumer, the search query including product data;
store the product data from the search query in one or more additional tables on the database;
determine that the product data in the search query matches at least a portion of the BNPL loan product data; and
based on the determination, transmit an alert message to the consumer computing device, the alert message including information identifying the BNPL loan.

2. The BNPL offer finder service system in accordance with claim 1,
the computer-executable instructions further causing the at least one processor to:
determine that the consumer is registered for an BNPL offer finder service; and
based on determining that the consumer is registered, determine whether the consumer selected to receive the alert message.

3. The BNPL offer finder service system in accordance with claim 2,
the computer-executable instructions further causing the at least one processor, as part of determining whether the consumer selected to receive the alert message, to:
retrieve a BNPL offer finder service account or profile for the consumer from the database; and
analyze information and data stored in the BNPL offer finder service account or profile to determine whether the data or information indicates that the consumer selected to receive the alert message.

4. The BNPL offer finder service system in accordance with claim 2,
the computer-executable instructions further causing the at least one processor, as part of determining that the product data in the search query matches at least a portion of the BNPL loan product data, to:
retrieve a BNPL offer finder service account or profile for the consumer from the database;
analyze information and data stored in the BNPL offer finder service account or profile; and
determine whether the data or information indicates that the consumer selected to receive the alert message corresponding to a BIN associated with a consumer payment card stored with the BNPL offer finder service account or profile for the consumer.

5. The BNPL offer finder service system in accordance with claim 4,
the computer-executable instructions further causing the at least one processor to compare the BIN of the BNPL loan product data to the BIN associated with a consumer payment card stored with the BNPL offer finder service account or profile for the consumer.

6. The BNPL offer finder system in accordance with claim 1,
the computer-executable instructions further causing the at least one processor to generate the alert message, including formatting the alert message in a format that can be received by a consumer computing device.

7. The BNPL offer finder system in accordance with claim 1,
the computer-executable instructions further causing the at least one processor to:
receive, from a merchant server, a BNPL offer, the BNPL offer corresponding to the BNPL loan available from the BNPL lender, the BNPL offer including a merchant location;
store the BNPL offer and merchant location in the database;
identify a location of the consumer computing device, the consumer computing device including a BNPL offer finder service application configured to provide the location of the consumer computing device; and
compare the identified location of the consumer computing device to the merchant location,
wherein the step of determining that the product data in the search query matches at least a portion of the BNPL loan product data further includes determining that a difference between the identified location of the consumer computing device and the merchant location is within a predefined threshold distance.

8. A computer-implemented method comprising:
receiving, from a Buy Now, Pay Later (BNPL) lender server, BNPL loan product data associated with a BNPL loan available from a BNPL lender, the BNPL loan product data including one or more of the following: a product, a product category, and a bank identification number (BIN);
storing the BNPL loan product data in one or more tables in a database;
receiving a search query from a consumer computing device associated with a consumer, the search query including product data;
storing the product data from the search query in one or more additional tables in the database;
determining that the product data in the search query matches at least a portion of the BNPL loan product data; and
based on the determination, transmitting an alert message to the consumer computing device, the alert message including information identifying the BNPL loan.

9. The computer-implemented method in accordance with claim 8, furthering comprising:
determining that the consumer is registered for an BNPL offer finder service; and
based on determining that the consumer is registered, determining whether the consumer selected to receive the alert message.

10. The computer-implemented method in accordance with claim 9, wherein determining whether the consumer selected to receive the alert message comprises:
retrieving a BNPL offer finder service account or profile for the consumer from the database; and
analyzing information and data stored in the BNPL offer finder service account or profile to determine whether the data or information indicates that the consumer selected to receive the alert message.

11. The computer-implemented method in accordance with claim 9, wherein determining that the product data in the search query matches at least a portion of the BNPL loan product data comprises:
retrieving a BNPL offer finder service account or profile for the consumer from the database;
analyzing information and data stored in the BNPL offer finder service account or profile; and
determining whether the data or information indicates that the consumer selected to receive the alert message corresponding to a BIN associated with a consumer payment card stored with the BNPL offer finder service account or profile for the consumer.

12. The computer-implemented method in accordance with claim 11, further comprising comparing the BIN of the BNPL loan product data to the BIN associated with a consumer payment card stored with the BNPL offer finder service account or profile for the consumer.

13. The computer-implemented method in accordance with claim 8, further comprising generating the alert message, including formatting the alert message in a format that can be received by a consumer computing device.

14. The computer-implemented method in accordance with claim 8, further comprising:
receiving, from a merchant server, a BNPL offer, the BNPL offer corresponding to the BNPL loan available from the BNPL lender, the BNPL offer including a merchant location;
storing the BNPL offer and merchant location in the database;
identifying a location of the consumer computing device, the consumer computing device including a BNPL offer finder service application configured to provide the location of the consumer computing device; and
comparing the identified location of the consumer computing device to the merchant location,
wherein the step of determining that the product data in the search query matches at least a portion of the BNPL loan product data further includes determining that a difference between the identified location of the consumer computing device and the merchant location is within a predefined threshold distance.

15. A non-transitory computer-readable storage media having computer-executable instructions stored thereon, wherein when executed by at least one processor the computer-executable instructions cause the at least one processor to:
receive, from a Buy Now, Pay Later (BNPL) lender server, BNPL loan product data associated with a BNPL loan available from a BNPL lender, the BNPL loan product data including one or more of the following: a product, a product category, and a bank identification number (BIN);
store the BNPL loan product data in one or more tables on a database;
receive a search query from a consumer computing device associated with a consumer, the search query including product data;
store the product data from the search query in one or more additional tables on the database;
determine that the product data in the search query matches at least a portion of the BNPL loan product data; and
based on the determination, transmit an alert message to the consumer computing device, the alert message including information identifying the BNPL loan.

16. The non-transitory computer-readable storage media of claim 15, wherein when executed by the at least one processor the computer-executable instructions further cause the at least one processor to:
determine that the consumer is registered for an BNPL offer finder service; and
based on determining that the consumer is registered, determine whether the consumer selected to receive the alert message.

17. The non-transitory computer-readable storage media of claim 16, wherein when executed by the at least one processor the computer-executable instructions further cause the at least one processor, as part of determining whether the consumer selected to receive the alert message, to:
retrieve a BNPL offer finder service account or profile for the consumer from the database; and
analyze information and data stored in the BNPL offer finder service account or profile to determine whether the data or information indicates that the consumer selected to receive the alert message.

18. The non-transitory computer-readable storage media of claim 16, wherein when executed by the at least one processor the computer-executable instructions further cause the at least one processor, as part of determining that the product data in the search query matches at least a portion of the BNPL loan product data, to:
retrieve a BNPL offer finder service account or profile for the consumer from the database;
analyze information and data stored in the BNPL offer finder service account or profile;
determine whether the data or information indicates that the consumer selected to receive the alert message corresponding to a BIN associated with a consumer payment card stored with the BNPL offer finder service account or profile for the consumer; and
compare the BIN of the BNPL loan product data to the BIN associated with a consumer payment card stored with the BNPL offer finder service account or profile for the consumer.

19. The non-transitory computer-readable storage media of claim 15, wherein when executed by the at least one processor the computer-executable instructions further cause the at least one processor to generate the alert message, including formatting the alert message in a format that can be received by a consumer computing device.

20. The non-transitory computer-readable storage media of claim 15, wherein when executed by the at least one processor the computer-executable instructions further cause the at least one processor to:
receive, from a merchant server, a BNPL offer, the BNPL offer corresponding to the BNPL loan available from the BNPL lender, the BNPL offer including a merchant location;
store the BNPL offer and merchant location in the database;
identifying a location of the consumer computing device, the consumer computing device including a BNPL offer finder service application configured to provide the location of the consumer computing device; and
comparing the identified location of the consumer computing device to the merchant location,
wherein the step of determining that the product data in the search query matches at least a portion of the BNPL loan product data further includes determining that a difference between the identified location of the consumer computing device and the merchant location is within a predefined threshold distance.
